(19) United States
(12) Patent Application Publication
(10) Pub. No.: US 2005/0007717 A1
(43) Pub. Date: Jan. 13, 2005

(54) [OFFSET CIRCUIT FOR SUPRESSING ELECTROMAGNETIC INTERFERENCE AND OPERATION METHOD THEREOF]

(76) Inventors: Kuo-Ming Chuang, Taipei County (TW); Yu-Chiang Cheng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,159

(22) Filed: Jun. 23, 2004

(30) Foreign Application Priority Data
Jun. 23, 2003 (TW) 92116942

(51) Int. Cl. H02H 9/06

(52) U.S. Cl. 361/118

(57) ABSTRACT

A circuit for suppressing electromagnetic interference (EMI) and operation method thereof is provided. Interfering signals captured or coupled from the motherboard are transmitted to the phase-shifter for shifting the phase of the signals. The interfering signals with phase shifted are outputted and coupled to the ground layer or the power-supply layer to offset EMI noise thereof. Since merely additional space for the phase shifter is reserved on the motherboard, EMI effect is eliminated and time and cost for rerouting the circuit is thus reduced.

### CROSS REFERENCE TO RELATED APPLICATIONS

This application claims the priority benefit of Taiwan application 92116942 filed on Jun. 23, 2003, a full disclosure of which is incorporated herein by reference.

### BACKGROUND OF INVENTION

1. Field of the Invention

The present invention relates to an offset circuit and operation method thereof, and more particularly, to an offset circuit for suppressing electromagnetic interference and operation method thereof.

2. Description of Related Art

For a motherboard that is currently used, components thereon, such as clock generator, are operated at an increasingly higher frequency, which incurs more serious electromagnetic interference (EMI) problems. Since EMI is harmful to human being, EMI generated by a motherboard is explicitly specified in statues over the countries. Therefore, it is desirable to effectively improve EMI issues of a motherboard.

Conventionally, the only solution to reduce EMI generated by a motherboard is to reroute the circuits thereon. Since it is not predictable to reroute circuits according to conventional method, the motherboard needs another reroute if EMI is still beyond the limit after primitive reroute, which incurs higher cost.

### SUMMARY OF INVENTION

In the light of the above descriptions, one object of the present invention is to phase shifting the interfering signals captured or coupled from the motherboard via a phase-shifter. The phase-shifted interfering signals are outputted to the ground layer or the power layer, then are offsetting the EMI generated thereof. It is noted that the motherboard is a printed circuit board, for example.

According to the above description, the present invention is directed to an offset circuit for suppressing EMI. The offset circuit is suitable for a motherboard, wherein the motherboard comprises a ground layer and a power layer, and either of the layers generates a noise incurring EMI. The offset circuit comprises a phase-shifter disposed on the motherboard, for receiving the interfering signals captured or coupled from the motherboard, phase-shifting the interfering signals, and outputting phase-shifted interfering signals to one of the ground layer and the power layer.

According to one embodiment of the present invention, the interfering signal is for offsetting the noise.

According to one embodiment of the present invention, the interfering signal is generated by the clock generator on the motherboard.

According to one embodiment of the present invention, the phase shifter is an inverter. Wherein the inverter serves to invert the interfering signal, and output the inverted interfering signals.

The present invention is also directed to an operational method of an offset circuit for suppressing EMI. The method is used for a motherboard having a ground layer and a power layer, wherein either of the layers generates a noise incurring EMI. The operational method comprises capturing or coupling the interfering signals from the motherboard, phase-shifting the interfering signals, and outputting the phase-shifted interfering signals to one of the ground layer and the power layer.

According to one embodiment of the present invention, the interfering signals are phase shifted and outputted by a phase shifter.

According to the above descriptions, the present invention comprises capturing or coupling interfering signals from the motherboard, phase-shifting which with a phase shifter and outputting the phase-shifted interfering signals to one of the ground layer and the power layer. The noise is offset by the EMI generated from the ground layer or the power layer. Since merely an additional space of the phase shifter is requested in the present invention, not only EMI is improved, but the reroute time and cost are reduced.

### BRIEF DESCRIPTION OF DRAWINGS

FIG. 1 is a schematic block diagram of an offset circuit for suppressing EMI according to one embodiment of the present invention.

### DETAILED DESCRIPTION

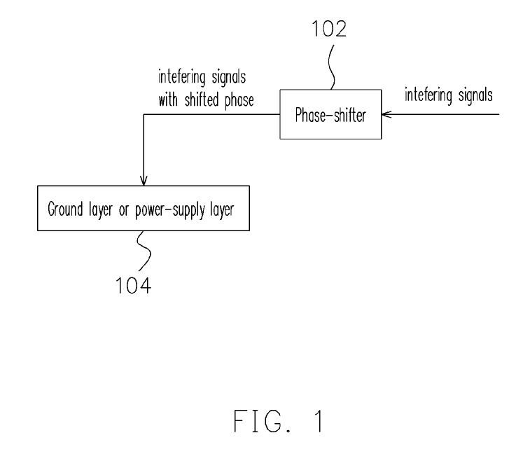

Referring to FIG. 1, it illustrates a schematic block diagram of an offset circuit for suppressing EMI according to one embodiment of the present invention. The offset circuit is suitable for a motherboard. The motherboard, e.g. a printed circuit board, comprises a ground layer and a power layer, wherein one of the ground layer and the power layer has a noise incurring EMI. In FIG. 1, the offset circuit comprises a phase shifter 102 disposed on the motherboard, for capturing or coupling interfering signals from the motherboard, phase-shifting the interfering signals, and outputting to one of the ground layer and the power layer 104. The noise incurring EMI of the ground layer or the power layer 104 is thus offset. It is noted that the interfering signals are captured or coupled from locations of motherboard where EMI is relatively more serious. Generally speaking, serious EMI is generated by signals with higher frequency, for example interfering signals are captured or coupled from the clock generator of a motherboard. Moreover, the phase shifter 102 is an inverter, for example. If using an inverter, the interfering signals are inverted, and outputting inverted interfering signals to the ground layer or the power layer 104 which generate the noise, such that cancel the noise incurring EMI that is originated from the ground or power layer 104.

Referring to FIG. 1 again for describing operation method of an offset circuit according to one embodiment of the present invention. The operation method comprises inputting the interfering signals to the phase shifter 102, phase shifting the interfering signals with the phase shifter, outputting the phase shifted interfering signals to the ground or power layer 104 where the noise is originally generated, and thus canceling the noise incurring EMI therefrom.

In the light of the above description,, the interfering signals captured or coupled from a motherboard is phase-shifted with a phase-shifter, and the phase-shifted interfering signals are outputted to the ground or power layer for canceling the noise incurring EMI generated thereby. Since merely a space of phase shifter is requested, not only EMI is suppressed, but time and cost of circuit reroute are reduced.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

1. An offset circuit for suppressing electromagnetic interference (EMI), suitable for a printed circuit board, the printed circuit board comprising a ground layer and a power layer, wherein one of the ground layer and the power layer generating a noise incurring EMI, the offset circuit comprising:
a phase shifter, disposed on the printed circuit board, for receiving an interfering signal captured or coupled from the printed circuit board, phase-shifting the interfering signal, and outputting the phase-shifted interfering signal to one of the ground layer and the power layer that generates the noise.

2. The offset circuit as recited in claim 1, wherein the interfering signal is for canceling the noise.

3. The offset circuit as recited in claim 1, wherein the interfering signal is generated by a clock generator of the printed circuit board

4. The offset circuit as recited in claim 1, wherein the phase shifter is an inverter.

5. The offset circuit as recited in claim 4, wherein the inverter is for inverting the interfering signal, and outputting an inverted interfering signal.

6. An operation method of an offset circuit for suppressing electromagnetic interference (EMI), suitable for a printed circuit board, the printed circuit board comprising a ground layer and a power layer, a noise is generated by one of the ground layer and the power layer, the operation method comprising:
capturing or coupling an interfering signal from the printed circuit board;
phase-shifting the interfering signal; and
outputting a phase-shifted interfering signal to one of the ground layer and the power layer where the noise is generated therefrom.

7. The operation method as recited in claim 6, wherein the interfering signal is for canceling the noise.

8. The operation method as recited in claim 6, wherein the interfering signal is generated from a clock generator of the printed circuit board.

9. The operation method as recited in claim 6, wherein a phase shifter is used for phase-shifting the interfering signal and outputting the phase-shifted interfering signal.

10. The operation method as recited in claim 9, wherein the phase shifter is an inverter.

11. The operation method as recited in claim 10, wherein the inverter serves to invert the interfering signal and output an inverted interfering signal.
